(19) United States
(12) Patent Application Publication
(10) Pub. No.: US 2010/0071610 A1
(43) Pub. Date: Mar. 25, 2010

(54) Tactile Guide for Actuators

(75) Inventor: Ted R. Greene, Poway, CA (US)

Correspondence Address: HIGGS, FLETCHER & MACK LLP, 401 West A Street, Suite 2600, SAN DIEGO, CA, 92101, US

(73) Assignee: United Security Products, Inc., Poway, CA (US)

(21) Appl. No.: 12/238,343

(22) Filed: Sep. 25, 2008

(51) Int. Cl. G01D 13/22

(52) U.S. Cl. 116/205

(57) ABSTRACT

A locating device includes a surface, an actuator, and a tactile guide coupled to the surface. The tactile guide extends from a location on the surface away from the actuator and terminates at a location on the surface adjacent to the actuator.

### BACKGROUND OF THE INVENTION

1. Field of the Invention

The present invention is directed generally to actuators such as push-buttons, levers and handles used in electrical switches and mechanical controls. More specifically, but without limitation thereto, the present invention is directed to a tactile guide for the actuator of an electrical switch.

2. Description of Related Art

Electrical switches are often placed in hidden locations so that they may be used to signal a robbery without revealing that the switch is being activated. Switches designed especially for this function are referred to as emergency buttons.

### SUMMARY OF THE INVENTION

In one embodiment, a locating device includes a surface, an actuator, and a tactile guide coupled to the surface. The tactile guide extends from a location on the surface away from the actuator and terminates at a location on the surface adjacent to the actuator.

### BRIEF DESCRIPTION OF THE DRAWINGS

The above and other aspects, features and advantages will become more apparent from the description in conjunction with the following drawings presented by way of example and not limitation, wherein like references indicate similar elements throughout the several views of the drawings, and wherein:

FIG. 1 illustrates a perspective view of a tactile guide for the actuator of an electrical switch;

FIG. 2 illustrates a top view of a tactile guide for an actuator that includes a series of substantially concentric rings having a spacing that decreases as a function of distance from the actuator;

FIG. 3 illustrates a perspective view of a tactile guide for the switch in FIG. 1 in the form of a slot;

FIG. 4 illustrates a perspective view of a tactile guide for the switch in FIG. 1 in the form of a line of raised bumps formed on the enclosure;

FIG. 5 illustrates a perspective view of a tactile guide for the switch in FIG. 1 in the form a line of indents or holes formed in the enclosure; and

FIG. 6 illustrates a perspective view of a tactile guide for the switch in FIG. 1 having a surface texture that contrasts with that of the enclosure.

Elements in the figures are illustrated for simplicity and clarity and have not necessarily been drawn to scale. For example, the dimensions, sizing, and/or relative placement of some of the elements in the figures may be exaggerated relative to other elements to clarify distinctive features of the illustrated embodiments. Also, common but well-understood elements that may be useful or necessary in a commercially feasible embodiment are often not depicted in order to facilitate a less obstructed view of the illustrated embodiments.

### DESCRIPTION OF THE ILLUSTRATED EMBODIMENTS

The following is a description of specific examples that embody general principles from which other embodiments may be derived. Accordingly, the illustrated embodiments are not intended to exclude other embodiments that may be derived from the same general principles within the scope of the appended claims. For example, certain actions or steps may be described or depicted in a specific order to be performed. However, practitioners of the art will understand that the specific order is only given by way of example and that the specific order does not exclude performing the described steps in another order to achieve substantially the same result. Also, the terms and expressions used in the description have the ordinary meanings accorded to such terms and expressions in the corresponding respective areas of inquiry and study except where other meanings have been specifically set forth herein.

In commercial environments such as stores and banks, it is often desirable to have an alarm switch that is hidden from view so that authorities may be notified of a robbery or attack by an employee without increasing the present danger to other employees and customers. Switches that are hidden from view for security reasons are often referred to as emergency buttons. Electrical switches used for controlling lighting, appliances, and other devices may also be difficult to locate due to poor lighting conditions, impaired vision, or stress induced by an emergency. A tactile guide that does not rely on a person's sense of sight advantageously avoids this problem and may provide other advantages as described herein.

In one embodiment, an apparatus includes a surface, an actuator, and a tactile guide coupled to the surface. The tactile guide extends from a location on the surface away from the actuator and terminates at a location on the surface adjacent to the actuator.

The term “surface” includes all structures on which an actuator may be placed, mounted, or otherwise attached. Examples of such a surface include but are not limited to an upper or lower surface of a table or counter, a wall of a building, and a control panel of a machine.

The term “actuator” includes all manually manipulated devices used to control electrical circuits and machines. Examples of an actuator include but are not limited to push-buttons, levers, knobs, doorknobs, cabinet and drawer pulls, and valve handles.

The term “tactile guide” is defined herein as a device that is capable of conveying an indication of the location of an actuator by means of a person's sense of touch. An indication of the direction leading to the location of the actuator is also an indication of the location of the actuator.

The term “away from the actuator” is defined herein to include being incapable of conveying an indication of the location of the actuator by means of a person's sense of touch other than that provided by the tactile guide. For example, a person would generally recognize where to find the actuator of a switch by touching the threaded shoulder that fastens the switch to a surface. Accordingly, a location on the threaded shoulder of a switch would generally not be “away from the actuator”. Likewise, a person would generally recognize where to find an actuator by touching the edge of an opening in an enclosure that surrounds the actuator. Accordingly, a location on the edge of the circular opening that surrounds the actuator would generally not be “away from the actuator”.

On the other hand, a person probably would not recognize where to find the actuator by touching a flat area of a wall, a panel, or of an enclosure on which a switch is mounted. Accordingly, locations in these areas would generally be “away from the actuator”.

The term “adjacent to the actuator” is defined herein to include being capable of conveying some indication of the location of the actuator by a person's sense of touch. For example, a person would probably recognize where to find the actuator by touching the threaded shoulder that fastens a switch to a surface or the edge of an opening in an enclosure that surrounds the actuator.

The examples used to illustrate the terms defined above are provided to assist in applying the definitions of the terms and do not limit the definitions to the scenarios described in the examples.

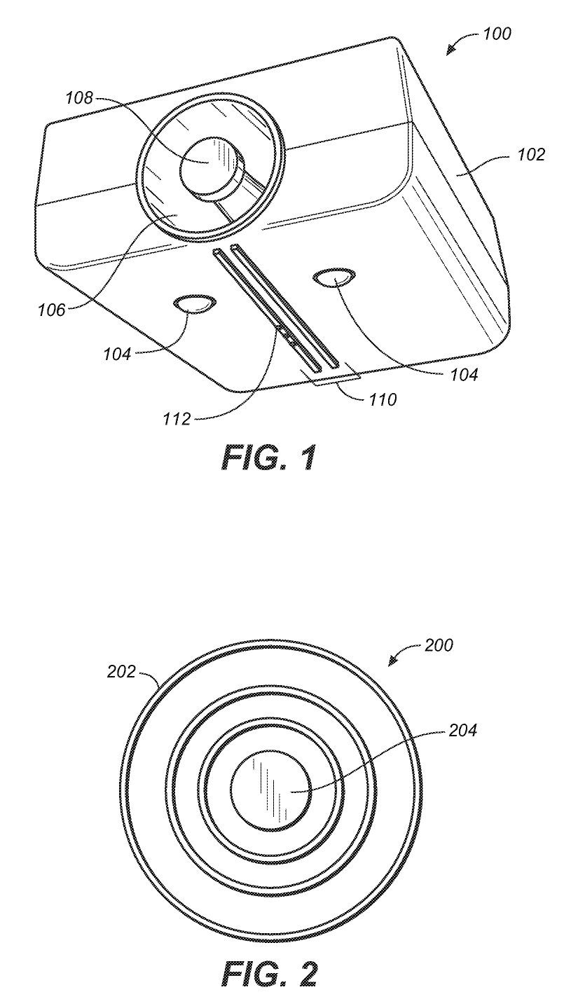

FIG. 1 illustrates a perspective view 100 of a tactile guide for the actuator of an electrical switch. Shown in FIG. 1 are an enclosure 102, fasteners 104, an opening 106, an actuator 108, a tactile guide 110, and a distance indicator 112.

In the embodiment of FIG. 1, the enclosure 102 may be any type of enclosure suitable for mounting an electrical switch according to well-known techniques. The enclosure 102 may be made, for example, of plastic, wood, glass, and other rigid materials. The fasteners 104 are used to fasten the enclosure 102 to a surface, for example, the bottom of a service counter behind a teller window in a bank. In other embodiments, the enclosure may be an electrical junction box fastened to a wall of a building or part of a control panel of a machine. The fasteners 104 may be, for example, wood screws, machine screws, nails, or other type of commercially available fasteners.

The opening 106 is a hole in the enclosure 102 that surrounds the actuator 108. In FIG. 1, the opening 106 is larger than the actuator 108, for example, twice the diameter of the actuator 108. The opening 106 may be used in various embodiments, for example, to prevent accidentally striking the actuator 108. In other embodiments, the opening 106 may fit closely around the actuator 108 so that the actuator 108 may be fastened directly to the enclosure 102, for example, by a threaded shoulder on the switch.

In one embodiment, the actuator 108 activates an electrical circuit by connecting a pair of switch contacts in the switch when a push-button is depressed. The switch contacts may be connected from the switch to an alarm system by wires according to well-known techniques. In another embodiment, the actuator 108 may produce a change in capacitance when touched, and the change in capacitance may be detected and amplified to activate an electrical circuit according to well-known techniques. In one embodiment, the actuator 108 may be connected to an alarm system by a wireless transmitter circuit that communicates with a receiver circuit in an alarm system. In yet another embodiment, the actuator 108 may be a lever, a handle, a knob, or a similar device that controls a mechanical device such as a brake release, a valve, a door, a cabinet, or a drawer. Other devices may be used to implement the actuator 108 according to well-known techniques to practice various embodiments within the scope of the appended claims.

The tactile guide 110 stimulates a person's sense of touch to indicate a direction that leads to the actuator 108. In FIG. 1, the tactile guide 110 includes a pair of parallel rails on a surface of the enclosure 110. In one embodiment, the parallel rails are separated by a distance of approximately 1.25 mm to approximately 5.1 mm. In another embodiment, each rail has a height and width of approximately 0.25 mm to approximately 1.3 mm. Other values for the spacing, height, and width of the parallel rails may be used to make the tactile guide 110 to practice various embodiments within the scope of the appended claims. The spacing between the rails helps a person to hold a finger between the rails while sliding the finger along the surface toward the actuator 108. In other embodiments, the tactile guide 110 is fastened or formed on a surface other than the enclosure 102, such as on a wall of a building or on the control panel of a machine. In further embodiments, the spacing may have a different width, for example, to accommodate the width of a hand. In another embodiment, the tactile guide 110 may be a single rail. In a further embodiment, the sides of the rails are vertical, as shown in FIG. 1. In other embodiments, the sides of the rails may be angled or curved on the inside to assist in centering the finger or hand. In a further embodiment, the tactile guide 110 may include multiple pairs of rails arranged according to well-known techniques in a radial pattern that is centered on the actuator 108 to assist in locating the actuator 108 over a wide area of an enclosure or on a wall. In another embodiment, the tactile guide 110 includes a series of concentric rings centered on the actuator.

In other embodiments, the tactile guide 110 may include the distance indicator 112, shown in FIG. 1 as a pattern of bumps. The distance indicator 112 is a tactile feature that communicates a distance from the distance indicator 112 to the actuator 108 by a person's sense of touch. In one embodiment, a series of four bumps indicates a distance of four inches to the actuator 108, a series of three bumps indicates a distance of three inches, and so on. Other tactile features may be incorporated in the distance indicator 112 to indicate the distance to the actuator 108 according to well-known techniques to practice various embodiments within the scope of the appended claims.

FIG. 2 illustrates a top view 200 of a tactile guide for an actuator that includes a series of substantially concentric rings having a spacing that decreases as a function of distance from the actuator. Shown in FIG. 2 are a series of concentric rings 202 and an actuator 108.

In the embodiment of FIG. 2, the series of concentric rings 202 may be, for example, raised ridges or slots formed in or fastened to a surface such as the enclosure 102, a wall of a building, or a control panel of a machine. The concentric rings 202 may advantageously be sensed by a person's sense of touch from any direction from the actuator 108. In FIG. 2, the spacing or separation between the rings decreases toward the actuator 204 to indicate the distance to the actuator 204.

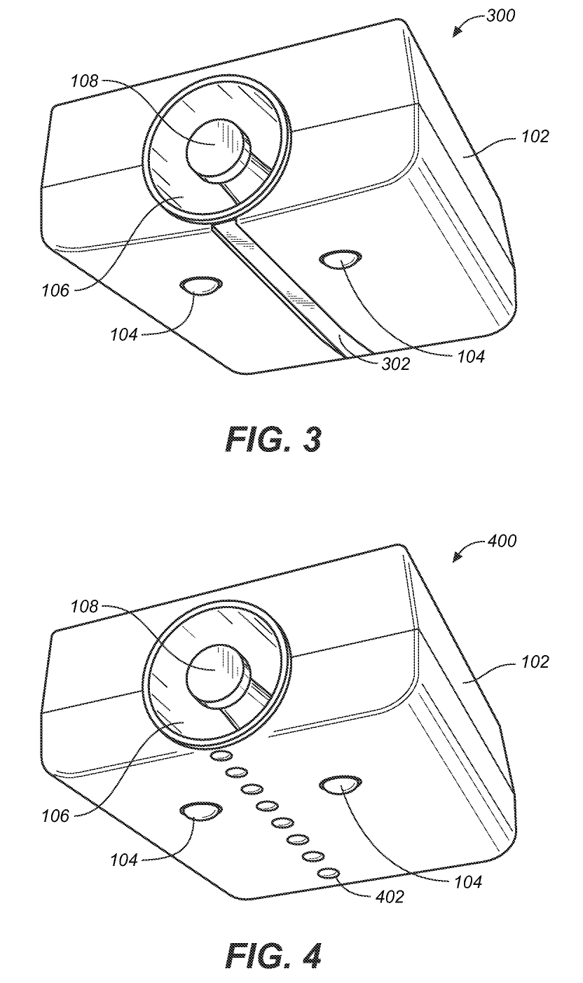

FIG. 3 illustrates a perspective view 300 of a tactile guide for the switch in FIG. 1 in the form of a slot. Shown in FIG. 3 are an enclosure 102, fasteners 104, an opening 106, an actuator 108, and a tactile guide 302.

In the embodiment of FIG. 3, the tactile guide 302 includes a slot having a width and a depth selected to help guide a finger along the slot to the actuator. In one embodiment, the slot has a width of approximately 1.25 mm to approximately 5.1 mm. In another embodiment, the slot has a depth of approximately 0.25 mm to approximately 1.3 mm. Other values for the width and depth of the slot may be used to practice various embodiments within the scope of the appended claims.

FIG. 4 illustrates a perspective view 400 of a tactile guide for the switch in FIG. 1 in the form of a line of raised bumps formed on the enclosure. Shown in FIG. 4 are an enclosure 102, fasteners 104, an opening 106, an actuator 108, and a tactile guide 402.

In the embodiment of FIG. 4, the tactile guide 402 includes a line of raised bumps leading toward the actuator 108. In another embodiment (not shown), the spacing between the bumps decreases as a function of distance from the actuator 108 to provide a tactile indication of the direction and the distance to the actuator 108.

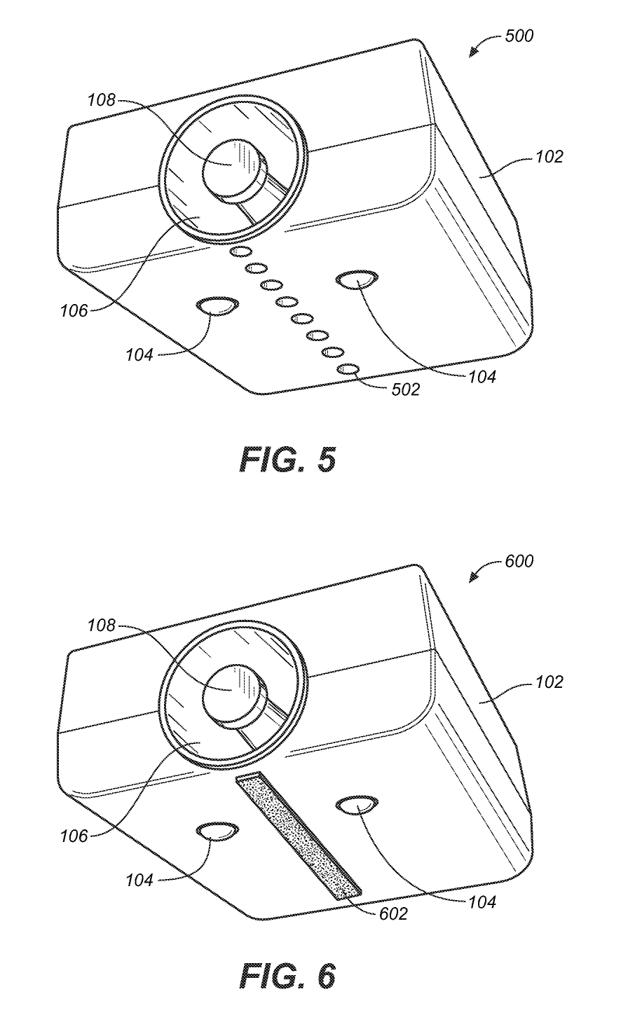

FIG. 5 illustrates a perspective view 500 of a tactile guide for the switch in FIG. 1 in the form of a line of indents or holes formed in the enclosure. Shown in FIG. 5 are an enclosure 102, fasteners 104, an opening 106, an actuator 108, and a tactile guide 502.

In the embodiment of FIG. 5, the tactile guide 502 includes a line of indents or holes in the enclosure 102 leading toward the actuator 108. In another embodiment (not shown), the spacing between the indents or holes decreases with distance from the actuator 108 to provide a tactile indication of the distance to the actuator 108.

FIG. 6 illustrates a perspective view 600 of a tactile guide for the switch in FIG. 1 having a surface texture that contrasts with that of the enclosure. Shown in FIG. 6 are an enclosure 102, fasteners 104, an opening 106, an actuator 108, and a tactile guide 602.

In the embodiment of FIG. 6, the tactile guide 602 leading toward the actuator 108 has a different surface texture from that of the enclosure 102. For example, if the enclosure 102 has a smooth surface, the tactile guide 602 may have a roughened texture that may easily be distinguished by touch from that of the enclosure 102. In another embodiment, the tactile guide 602 may include a series of bumps or a similar tactile feature to indicate the distance to the actuator 108.

With the exception of FIG. 2, the tactile guides illustrated in the above examples are shown generally in a straight line. In other embodiments, the tactile guides may include angles and curves. Accordingly, the specific embodiments and applications thereof described above are for illustrative purposes only and do not preclude modifications and variations that may be made within the scope of the following claims.

What is claimed is:

1. An apparatus comprising:
a surface;
an actuator; and
a tactile guide coupled to the surface, the tactile guide extending from a location on the surface away from the actuator and terminating at a location on the surface adjacent to the actuator.

2. The apparatus of claim 1 further comprising an enclosure that includes the surface.

3. The apparatus of claim 2 comprising the actuator fastened to the enclosure.

4. The apparatus of claim 1 comprising the tactile guide formed substantially in a straight line.

5. The apparatus of claim 1 comprising the tactile guide formed in a series of substantially concentric circles.

6. The apparatus of claim 1 comprising the tactile guide formed as a ridge on the enclosure.

7. The apparatus of claim 1 comprising the tactile guide formed as a slot in the enclosure.

8. The apparatus of claim 1 comprising the tactile guide formed as a plurality of bumps on the enclosure.

9. The apparatus of claim 1 comprising the tactile guide formed as a plurality of indents or holes in the enclosure.

10. The apparatus of claim 1 comprising the tactile guide having a texture that contrasts with that of the enclosure.

11. The apparatus of claim 1 comprising the tactile guide formed as a pair of parallel rails.

12. The apparatus of claim 11 comprising a spacing between the pair of parallel rails for guiding a finger along the surface to the actuator.

13. The apparatus of claim 11 comprising multiple tactile guides arranged in a radial pattern centered on the actuator.

14. The apparatus of claim 1 comprising a fastener for fastening the actuator to the enclosure.

15. The apparatus of claim 1 comprising an opening in the enclosure that surrounds the actuator.

16. The apparatus of claim 1 comprising the tactile guide including a tactile feature indicative of the distance to the actuator.

17. The apparatus of claim 1 comprising the actuator coupled to electrical contacts that make electrical contact when the actuator is depressed.

18. The apparatus of claim 1 comprising the actuator having an electrical capacitance that changes value when the actuator is touched.

19. The apparatus of claim 1 comprising the actuator coupled to a mechanical device.

20. The apparatus of claim 19 comprising the actuator coupled to a valve.
